(19) United States
(12) Patent Application Publication
(10) Pub. No.: US 2023/0276858 A1
(43) Pub. Date: Sep. 7, 2023

(54) AEROSOL PROVISION SYSTEMS

(71) Applicant: Nicoventures Trading Limited, London (GB)

(72) Inventors: Sean A. Daugherty, Yadkinville, NC (US); Simon Poynton, London (GB)

(21) Appl. No.: 17/687,198

(22) Filed: Mar. 4, 2022

(51) Int. Cl. A24F 40/53; A24F 40/51; A24F 40/65

(52) U.S. Cl. CPC A24F 40/53; A24F 40/51; A24F 40/65

(57) ABSTRACT

An aerosol delivery system for generating aerosol from a consumable part, the aerosol delivery system including: a sensor; and a controller, wherein the controller is configured to: establish a target operating characteristic for the aerosol delivery system; establish, using the sensor, identifying information associated with a consumable part coupled to the aerosol delivery system; identify the consumable part is one of a plurality of different types of consumable part, based on the identifying information; and control at least one aspect of the operation of the aerosol delivery system on the basis of the target operating characteristic of the aerosol delivery system and the identifying information associated with at least one consumable part coupled to the aerosol delivery system.

### FIELD

The present disclosure relates to aerosol delivery systems.

### BACKGROUND

Aerosol delivery systems such as electronic cigarettes (e-cigarettes) generally contain a aerosol generating material, such as a reservoir of a source liquid, which may contain an active substance and/or a flavour, from which an aerosol or vapour is generated for inhalation by a user, for example through heat vaporisation. Thus, an aerosol provision system will typically comprise a aerosol generation chamber containing an aerosol generator, e.g. a heating element, arranged to vaporise or aerosolise a portion of precursor material to generate a vapour or aerosol in the aerosol generation chamber. As a user inhales on the device and electrical power is supplied to the vaporiser, air is drawn into the device through an inlet hole and along an inlet air channel connecting to the aerosol generation chamber where the air mixes with vaporised precursor material to form a condensation aerosol. There is an outlet air channel connecting from the aerosol generation chamber to an outlet in the mouthpiece and the air drawn into the aerosol generation chamber as a user inhales on the mouthpiece continues along the outlet flow path to the mouthpiece outlet, carrying the aerosol with it, for inhalation by the user. Some electronic cigarettes may also include a flavour element in the air flow path through the device to impart additional flavours. Such devices may sometimes be referred to as hybrid devices, and the flavour element may, for example, include a portion of tobacco arranged in the air flow path between the aerosol generation chamber and the mouthpiece such that aerosol/condensation aerosol drawn through the device passes through the portion of tobacco before exiting the mouthpiece for user inhalation.

Aerosol delivery systems typically operate according to at least one control parameter which may be modified in order to change the operating characteristics of the system. For example, it is known to allow a user to modify a power delivered to a heater of an aerosol delivery system in order to seek to change characteristics of aerosol generated by the system. It is of interest to develop approaches in which an aerosol delivery system comprises functionality enabling operating characteristics of the system to be adjusted automatically in order to target certain operating characteristics which may be desirable to a user. Various approaches are described herein which seek to help address or mitigate at least some of the issues discussed above.

### SUMMARY

According to a first aspect of the present disclosure, there is provided an aerosol delivery system for generating aerosol from a consumable part, the aerosol delivery system comprising: a sensor; and a controller, wherein the controller is configured to: establish a target operating characteristic for the aerosol delivery system; establish, using the sensor, identifying information associated with a consumable part coupled to the aerosol delivery system; identify the consumable part is one of a plurality of different types of consumable part, based on the identifying information; and control at least one aspect of the operation of the aerosol delivery system on the basis of the target operating characteristic of the aerosol delivery system and the identifying information associated with at least one consumable part coupled to the aerosol delivery system.

According to a second aspect of the present disclosure, there is provided a method of controlling an aerosol delivery system comprising a sensor and a controller, the method comprising operating the controller to carry out the steps of: establishing a target operating characteristic for the aerosol delivery system; establishing, using the sensor, identifying information associated with at least one consumable part coupled to the aerosol delivery system; identifying the consumable part is one of a plurality of different consumable part types, based on the identifying information; and controlling at least one aspect of the operation of the aerosol delivery system on the basis of the target operating characteristic of the aerosol delivery system and the identifying information associated with at least one consumable part coupled to the aerosol delivery system.

According to a third aspect of the present disclosure, there is provided a computer readable storage medium comprising instructions which, when executed by a processor, performs the method of the second aspect.

According to a fourth aspect of the present disclosure, there is provided an electronic device, the electronic device comprising: a sensor; a transceiver configured to establish a data connection with an aerosol delivery system; and a controller, wherein the controller is configured to: establish a target operating characteristic for the aerosol delivery system; establish, via the sensor, identifying information associated with at least one consumable part coupled to the aerosol delivery system; identify the consumable part is one of a plurality of different consumable part types, based on the identifying information; and transmit to the aerosol delivery system, via the transceiver, control data for controlling at least one aspect of the operation of the aerosol delivery system on the basis of the target operating characteristic of the aerosol delivery system and the identifying information associated with at least one consumable part coupled to the aerosol delivery system.

According to a fifth aspect of the present disclosure, there are provided aerosol delivery system means for generating aerosol from a consumable part, the aerosol delivery system means comprising: sensor means; and controller means, wherein the controller means are configured to: establish a target operating characteristic for the aerosol delivery system means; establish, using the sensor means, identifying information associated with consumable part means coupled to the aerosol delivery system means; identify the consumable part is one of a plurality of different types of consumable part, based on the identifying information; and control at least one aspect of the operation of the aerosol delivery system means on the basis of the target operating characteristic of the aerosol delivery system means and the identifying information associated with at least one consumable part means coupled to the aerosol delivery system means.

### BRIEF DESCRIPTION OF THE DRAWINGS

Embodiments of the disclosure will now be described, by way of example only, with reference to the accompanying drawings, in which:

FIG. 1 is a schematic diagram of an aerosol delivery system in accordance with some embodiments of the disclosure.

FIG. 2 is a schematic diagram of a data communication environment in which an aerosol delivery system is configured to transmit and receive data to and from one or more external electronic devices.

FIG. 3 is a flowchart outlining an approach for operating an aerosol delivery system according to the present disclosure.

### DETAILED DESCRIPTION

Aspects and features of certain examples and embodiments are discussed/described herein. Some aspects and features of certain examples and embodiments may be implemented conventionally and these are not discussed/described in detail in the interests of brevity. It will thus be appreciated that aspects and features of apparatus and methods discussed herein which are not described in detail may be implemented in accordance with any conventional techniques for implementing such aspects and features.

The present disclosure relates to aerosol delivery systems (which may also be referred to as vapour delivery systems) such as nebulisers or e-cigarettes. Throughout the following description the term “e-cigarette” or “electronic cigarette” may sometimes be used, but it will be appreciated this term may be used interchangeably with aerosol delivery system/device and electronic aerosol delivery system/device. Furthermore, and as is common in the technical field, the terms “aerosol” and “vapour”, and related terms such as “vaporise”, “volatilise” and “aerosolise”, may generally be used interchangeably.

Aerosol delivery systems (e-cigarettes) often, though not always, comprise a modular assembly including both a reusable part and a replaceable (disposable) cartridge part. Often the replaceable cartridge part will comprise the aerosol generating material and the vaporiser and the reusable part will comprise the power supply (e.g. rechargeable power source) and control circuitry. It will be appreciated these different parts may comprise further elements depending on functionality. For example, the reusable device part will often comprise a user interface for receiving user input and displaying operating status characteristics, and the replaceable cartridge part in some cases comprises a temperature sensor for helping to control temperature. Cartridges are electrically and mechanically coupled to a control unit for use, for example using a screw thread, bayonet, or magnetic coupling with appropriately arranged electrical contacts. When the aerosol generating material in a cartridge is exhausted, or the user wishes to switch to a different cartridge having a different aerosol generating material, a cartridge may be removed from the control unit and a replacement cartridge attached in its place. Devices conforming to this type of two-part modular configuration may generally be referred to as two-part devices.

It is common for electronic cigarettes to have a generally elongate shape. For the sake of providing a concrete example, certain embodiments of the disclosure described herein will be taken to comprise this kind of generally elongate two-part device employing disposable cartridges. However, it will be appreciated the underlying principles described herein may equally be adopted for different aerosol delivery system configurations, for example single-part devices or modular devices comprising more than two parts, refillable devices and single-use disposable devices, as well as devices conforming to other overall shapes, for example based on so-called box-mod high performance devices that typically have a more boxy shape. More generally, it will be appreciated certain embodiments of the disclosure are based on aerosol delivery systems which are operationally configured to provide functionality in accordance with the principles described herein and the constructional aspects of the aerosol delivery systems configured to provide the functionality in accordance with certain embodiments of the disclosure is not of primary significance.

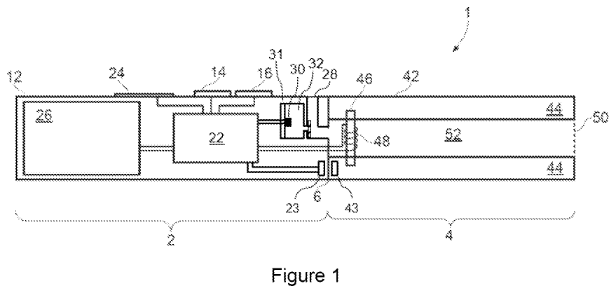

FIG. 1 is a cross-sectional view through an example aerosol delivery system 1 in accordance with certain embodiments of the disclosure. The aerosol delivery system 1 comprises two main components, namely a reusable part 2 and a replaceable/disposable cartridge part 4. In normal use the reusable part 2 and the cartridge part 4 are releasably coupled together at an interface 6. When the cartridge part is exhausted or the user simply wishes to switch to a different cartridge part, the cartridge part may be removed from the reusable part and a replacement cartridge part attached to the reusable part in its place. The interface 6 provides a structural, electrical and airflow path connection between the two parts and may be established in accordance with conventional techniques, for example based around a screw thread, magnetic or bayonet fixing with appropriately arranged electrical contacts and openings for establishing the electrical connection and airflow path between the two parts as appropriate. The specific manner by which the cartridge part 4 mechanically mounts to the reusable part 2 is not significant to the principles described herein, but for the sake of a concrete example is assumed here to comprise a magnetic coupling (not represented in FIG. 1). It will also be appreciated the interface 6 in some implementations may not support an electrical and/or airflow path connection between the respective parts. For example, in some implementations an aerosol generator may be provided in the reusable part 2 rather than in the cartridge part 4, or the transfer of electrical power from the reusable part 2 to the cartridge part 4 may be wireless (e.g. based on electromagnetic induction), so that an electrical connection between the reusable part and the cartridge part is not needed. Furthermore, in some implementations the airflow through the electronic cigarette might not go through the reusable part so that an airflow path connection between the reusable part and the cartridge part is not needed. In some instances, a portion of the airflow path may be defined at the interface between portions of reusable part 2 and cartridge part 4 when these are coupled together for use.

The cartridge/consumable part 4 may in accordance with certain embodiments of the disclosure be broadly conventional. In FIG. 1, the cartridge part 4 comprises a cartridge housing 42 formed of a plastics material. The cartridge housing 42 supports other components of the cartridge part and provides the mechanical interface 6 with the reusable part 2. The cartridge housing is generally circularly symmetric about a longitudinal axis along which the cartridge part couples to the reusable part 2. In this example the cartridge part has a length of around 4 cm and a diameter of around 1.5 cm. However, it will be appreciated the specific geometry, and more generally the overall shapes and materials used, may be different in different implementations.

Within the cartridge housing 42 is a reservoir 44 that contains aerosol generating material. Aerosol-generating material is a material that is capable of generating aerosol, for example when heated, irradiated or energized in any other way. Aerosol-generating material may, for example, be in the form of a solid, liquid or gel which may or may not contain an active substance and/or flavourants. In some embodiments, the aerosol-generating material may comprise plant material such as tobacco. In some embodiments, the aerosol-generating material may comprise an “amorphous solid”, which may alternatively be referred to as a “monolithic solid” (i.e. non-fibrous). In some embodiments, the amorphous solid may be a dried gel. The amorphous solid is a solid material that may retain some fluid, such as liquid, within it. In some embodiments, the aerosol-generating material may for example comprise from about 50 wt %, 60 wt % or 70 wt % of amorphous solid, to about 90 wt %, 95 wt % or 100 wt % of amorphous solid. The aerosol-generating material may comprise one or more active substances and/or flavours, one or more aerosol-former materials, and optionally one or more other functional material. The aerosol-former material may comprise one or more constituents capable of forming an aerosol. In some embodiments, the aerosol-former material may comprise one or more of glycerine, glycerol, propylene glycol, diethylene glycol, triethylene glycol, tetraethylene glycol, 1,3-butylene glycol, erythritol, meso-Erythritol, ethyl vanillate, ethyl laurate, a diethyl suberate, triethyl citrate, triacetin, a diacetin mixture, benzyl benzoate, benzyl phenyl acetate, tributyrin, lauryl acetate, lauric acid, myristic acid, and propylene carbonate. The one or more other functional materials may comprise one or more of pH regulators, colouring agents, preservatives, binders, fillers, stabilizers, and/or antioxidants. The aerosol-generating material may be present on or in a support, to form a substrate. The support may, for example, be or comprise paper, card, paperboard, cardboard, reconstituted material, a plastics material, a ceramic material, a composite material, glass, a metal, or a metal alloy.

One or more active constituents/substances comprised in the consumable part may comprise one or more physiologically and/or olfactory active constituents which are included in the aerosolisable material in order to achieve a physiological and/or olfactory response in the user.

In some embodiments, the active constituent is a physiologically active constituent and may be selected from nicotine, nicotine salts (e.g. nicotine ditartrate/nicotine bitartrate), nicotine-free tobacco substitutes, other alkaloids such as caffeine, cannabinoids, or mixtures thereof. Cannabinoids are a class of natural or synthetic chemical compounds which act on cannabinoid receptors (i.e., CB1 and CB2) in cells that repress neurotransmitter release in the brain. Two of the most important cannabinoids are tetrahydrocannabinol (THC) and cannabidiol (CBD). Cannabinoids may be naturally occurring (Phytocannabinoids) from plants such as cannabis, (endocannabinoids) from animals, and artificially manufactured (Synthetic cannabinoids). Cannabinoids are cyclic molecules exhibiting particular properties such as the ability to easily cross the blood-brain barrier, weak toxicity, and few side effects. Cannabis species express at least 85 different phytocannabinoids, and are divided into subclasses, including cannabigerols, cannabichromenes, cannabidiols, tetrahydrocannabinols, cannabinols and cannabinodiols, and other cannabinoids. such as cannabigerol (CBG), cannabichromene (CBC), cannabidiol (CBD), tetrahydrocannabinol (THC), cannabinol (CBN) and cannabinodiol (CBDL), cannabicyclol (CBL), cannabivarin (CBV), tetrahydrocannabivarin (THCV), cannabidivarin (CBDV), cannabichromevarin (CBCV), cannabigerovarin (CBGV), cannabigerol monomethyl ether (CBGM), cannabinerolic acid, cannabidiolic acid (CBDA), Cannabinol propyl variant (CBNV), cannabitriol (CBO), tetrahydrocannabmolic acid (THCA), and tetrahydrocannabivarinic acid (THCV A).

In the example shown schematically in FIG. 1, a reservoir 44 is provided configured to store a supply of liquid aerosol generating material. In this example, the liquid reservoir 44 has an annular shape with an outer wall defined by the cartridge housing 42 and an inner wall that defines an airflow path 52 through the cartridge part 4. The reservoir 44 is closed at each end with end walls to contain the aerosol generating material. The reservoir 44 may be formed in accordance with conventional techniques, for example it may comprise a plastics material and be integrally moulded with the cartridge housing 42.

The cartridge (which may also be referred to herein as a consumable part) further comprises an aerosol generator 48 located towards an end of the reservoir 44 opposite to the mouthpiece outlet 50. An aerosol generator is an apparatus configured to cause aerosol to be generated from the aerosol-generating material. In some embodiments, the aerosol generator is a heater configured to subject the aerosol-generating material to heat energy, so as to release one or more volatiles from the aerosol-generating material to form an aerosol. In some embodiments, the aerosol generator is configured to cause an aerosol to be generated from the aerosol-generating material without heating. For example, the aerosol generator may be configured to subject the aerosol-generating material to one or more of vibration, increased pressure, or electrostatic energy.

It will be appreciated that in a two-part device such as shown in FIG. 1, the aerosol generator may be in either of the reusable part 2 or the cartridge part 4. For example, in some embodiments, the aerosol generator 48 (e.g. a heater) may be comprised in the reusable part 2, and is brought into proximity with a portion of aerosol generating material in the cartridge 4 when the cartridge is engaged with the reusable part 2. In such embodiments, the cartridge may comprise a portion of aerosol generating material, and an aerosol generator 48 comprising a heater is at least partially inserted into or at least partially surrounds the portion of aerosol generating material as the cartridge 4 is engaged with the reusable part 2.

In the example of FIG. 1, a wick 46 in contact with a heater 48 extends transversely across the cartridge airflow path 52 with its ends extending into the reservoir 44 of a liquid aerosol generating material through openings in the inner wall of the reservoir 44. The openings in the inner wall of the reservoir are sized to broadly match the dimensions of the wick 46 to provide a reasonable seal against leakage from the liquid reservoir into the cartridge airflow path without unduly compressing the wick, which may be detrimental to its fluid transfer performance.

The wick 46 and heater 48 are arranged in the cartridge airflow path 52 such that a region of the cartridge airflow path 52 around the wick 46 and heater 48 in effect defines a vaporisation region for the cartridge part 4. Aerosol generating material in the reservoir 44 infiltrates the wick 46 through the ends of the wick extending into the reservoir 44 and is drawn along the wick by surface tension/capillary action (i.e. wicking). The heater 48 in this example comprises an electrically resistive wire coiled around the wick 46. In the example of FIG. 1, the heater 48 comprises a nickel chrome alloy (Cr20Ni80) wire and the wick 46 comprises a glass fibre bundle, but it will be appreciated the specific aerosol generator configuration is not significant to the principles described herein. In use electrical power may be supplied to the heater 48 to vaporise an amount of aerosol generating material (aerosol generating material) drawn to the vicinity of the heater 48 by the wick 46. Vaporised aerosol generating material may then become entrained in air drawn along the cartridge airflow path from the vaporisation region towards the mouthpiece outlet 50 for user inhalation.

As noted above, the rate at which aerosol generating material is vaporised by the vaporiser (heater) 48 will depend on the amount (level) of power supplied to the heater 48. Thus electrical power can be applied to the heater to selectively generate aerosol from the aerosol generating material in the cartridge part 4, and furthermore, the rate of aerosol generation can be changed by changing the amount of power supplied to the heater 48, for example through pulse width and/or frequency modulation techniques.

The reusable part 2 comprises an outer housing 12 having with an opening that defines an air inlet 28 for the e-cigarette, a power source 26 (for example a battery) for providing operating power for the electronic cigarette, control circuitry/controller 22 for controlling and monitoring the operation of the electronic cigarette, a first user input button 14, a second user input button 16, and a visual display 24.

The outer housing 12 may be formed, for example, from a plastics or metallic material and in this example has a circular cross section generally conforming to the shape and size of the cartridge part 4 so as to provide a smooth transition between the two parts at the interface 6. In this example the reusable part has a length of around 8 cm so the overall length of the e-cigarette when the cartridge part and reusable part are coupled together is around 12 cm. However, and as already noted, it will be appreciated that the overall shape and scale of an electronic cigarette implementing an embodiment of the disclosure is not significant to the principles described herein.

The air inlet 28 connects to an airflow path 51 through the reusable part 2. The reusable part airflow path 51 in turn connects to the cartridge airflow path 52 across the interface 6 when the reusable part 2 and cartridge part 4 are connected together. Thus, when a user inhales on the mouthpiece opening 50, air is drawn in through the air inlet 28, along the reusable part airflow path 51, across the interface 6, through the aerosol generation region in the vicinity of the aerosol generator 48 (where vaporised aerosol generating material becomes entrained in the air flow), along the cartridge airflow path 52, and out through the mouthpiece opening 50 for user inhalation.

The power source 26 in this example is rechargeable and may be of a conventional type, for example of the kind normally used in electronic cigarettes and other applications requiring provision of relatively high currents over relatively short periods. The power source 26 may be recharged through a charging connector in the reusable part housing 12, for example a USB connector.

First and second user input buttons 14, 16 may be provided, which in this example are conventional mechanical buttons, for example comprising a spring mounted component which may be pressed by a user to establish an electrical contact. In this regard, the input buttons may be considered input devices for detecting user input and the specific manner in which the buttons are implemented is not significant. The buttons may be assigned to functions such as switching the aerosol delivery system 1 on and off, and adjusting user settings such as a power to be supplied from the power source 26 to an aerosol generator 48. However, the inclusion of user input buttons is optional, and in some embodiments buttons may not be included.

A display 24 may be provided to give a user with a visual indication of various characteristics associated with the aerosol delivery system, for example current power setting information, remaining power source power, and so forth. The display may be implemented in various ways. In this example the display 24 comprises a conventional pixilated LCD screen that may be driven to display the desired information in accordance with conventional techniques. In other implementations the display may comprise one or more discrete indicators, for example LEDs, that are arranged to display the desired information, for example through particular colours and/or flash sequences. More generally, the manner in which the display is provided and information is displayed to a user using the display is not significant to the principles described herein. For example some embodiments may not include a visual display and may include other means for providing a user with information relating to operating characteristics of the aerosol delivery system, for example using audio signalling, or may not include any means for providing a user with information relating to operating characteristics of the aerosol delivery system.

A controller 22 is suitably configured/programmed to control the operation of the aerosol delivery system to provide functionality in accordance with embodiments of the disclosure as described further herein, as well as for providing conventional operating functions of the aerosol delivery system in line with the established techniques for controlling such devices. The controller (processor circuitry) 22 may be considered to logically comprise various sub-units/circuitry elements associated with different aspects of the operation of the aerosol delivery system 1. In this example the controller 22 comprises power supply control circuitry for controlling the supply of power from the power source 26 to the aerosol generator 48 in response to user input, user programming circuitry 20 for establishing configuration settings (e.g. user-defined power settings) in response to user input, as well as other functional units/circuitry associated functionality in accordance with the principles described herein and conventional operating aspects of electronic cigarettes, such as display driving circuitry and user input detection circuitry. It will be appreciated the functionality of the controller 22 can be provided in various different ways, for example using one or more suitably programmed programmable computer(s) and/or one or more suitably configured application-specific integrated circuit(s)/circuitry/chip(s)/chipset(s) configured to provide the desired functionality. The functionality of the controller 22 is described further herein. For example, the controller 26 may comprise an application specific integrated circuit (ASIC) or microcontroller, for controlling the aerosol delivery device. The microcontroller or ASIC may include a CPU or micro-processor. The operations of a CPU and other electronic components are generally controlled at least in part by software programs running on the CPU (or other component). Such software programs may be stored in non-volatile memory, such as ROM, which can be integrated into the microcontroller itself, or provided as a separate component. The CPU may access the ROM to load and execute individual software programs as and when required.

Reusable part 2 comprises an airflow sensor 30 which is electrically connected to the controller 22. In most embodiments, the airflow sensor 30 comprises a so-called “puff sensor”, in that the airflow sensor 30 is used to detect when a user is puffing on the device. In some embodiments, the airflow sensor comprises a switch in an electrical path providing electrical power from the power source 26 to the aerosol generator 48. In such embodiments, the airflow sensor 30 generally comprises a pressure sensor configured to close the switch when subjected to an particular range of pressures, enabling current to flow from the power source 26 to the aerosol generator 48 once the pressure in the vicinity of the airflow sensor 30 drops below a threshold value. The threshold value can be set to a value determined by experimentation to correspond to a characteristic value associated with the initiation of a user puff. In other embodiments, the airflow sensor 30 is connected to the controller 22, and the controller distributes electrical power from the power source 26 to the aerosol generator 48 in dependence of a signal received from the airflow sensor 30 by the controller 22. The specific manner in which the signal output from the airflow sensor 30 (which may comprise a measure of capacitance, resistance or other characteristic of the airflow sensor, made by the controller 22) is used by the controller 22 to control the supply of power from the power source 26 to the aerosol generator 48 can be carried out in accordance with any approach known to the skilled person.

In the example shown in FIG. 1, the airflow sensor 30 is mounted to a printed circuit board 31 as described further herein, but this is not essential. The airflow sensor 30 may comprise any sensor which is configured to determine a characteristic of airflow in an airflow path 51 disposed between air inlet 28 and mouthpiece opening 50, for example a pressure sensor or transducer (for example a membrane or solid-state pressure sensor), a combined temperature and pressure sensor, or a microphone (for example an electret-type microphone), which is sensitive to changes in air pressure, including acoustical signals. The airflow sensor is situated within a sensor cavity 32, which comprises the interior space defined by one or more chamber walls 34. The sensor cavity 32 may also be referred to herein as a sensor chamber 32 (these terms may be used interchangeably), and comprises a region internal to one or more chamber walls 34 in which an airflow sensor 30 can be fully or partially situated. In some embodiments, the airflow sensor 30 is mounted to a printed circuit board (PCB) 31, which comprises one of the chamber walls of a sensor housing comprising the sensor chamber/cavity 32. A deformable membrane is disposed across an opening communicating between the sensor cavity 32 containing the sensor 30, and a portion of the airflow path disposed between air inlet 28 and mouthpiece opening 50. The deformable membrane covers the opening, and is attached to one or more of the chamber walls according to approaches described further herein.

As described further herein, the aerosol delivery device 1 comprises communication circuitry configured to enable a connection to be established with one or more further electronic devices (for example, a storage/charging case, and/or a refill/charging dock) to enable data transfer between the aerosol delivery device 1 and further electronic device(s). In some embodiments, the communication circuitry is integrated into controller 22, and in other embodiments it is implemented separately (comprising, for example, separate application-specific integrated circuit(s)/circuitry/chip(s)/chipset(s)). For example, the communication circuitry may comprise a separate module to the controller 22 which, while connected to controller 22, provides dedicated data transfer functionality for the aerosol delivery device. In some embodiments, the communication circuitry is configured to support communication between the aerosol delivery device 1 and one or more further electronic devices over a wireless interface. The communication circuitry may be configured to support wireless communications between the aerosol delivery device 1 and other electronic devices such as a case, a dock, a computing device such as a smartphone or PC, a base station supporting cellular communications, a relay node providing an onward connection to a base station, a wearable device, or any other portable or fixed device which supports wireless communications.

Wireless communications between the aerosol delivery device 1 and a further electronic device may be configured according to known data transfer protocols such as Bluetooth, ZigBee, WiFi, Wifi Direct, GSM, 2G, 3G, 4G, 5G, LTE, NFC, RFID. More generally, it will be appreciated that any wireless network protocol can in principle be used to support wireless communication between the aerosol delivery device 1 and further electronic devices. In some embodiments, the communication circuitry is configured to support communication between the aerosol delivery device 1 and one or more further electronic devices over a wired interface. This may be instead of or in addition to the configuration for wireless communications set out above. The communication circuitry may comprise any suitable interface for wired data connection, such as USB-C, micro-USB or Thunderbolt interfaces. More generally, it will be appreciated the communication circuitry may comprise any wired communication interface which enables the transfer of data, according to, for example, a packet data transfer protocol, and may comprise pin or contact pad arrangements configured to engage cooperating pins or contact pads on a dock, case, cable, or other external device which can be connected to the aerosol delivery device 1.

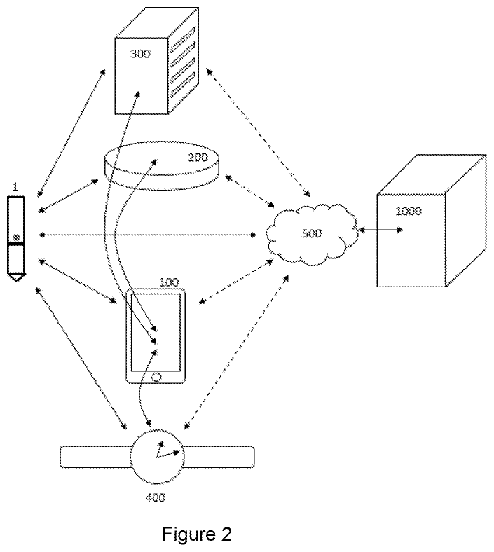

Referring now to FIG. 2, the aerosol delivery device 1 (or more generally any delivery device as described elsewhere herein) may operate within a wider delivery system/aerosol delivery system comprising one or more of a smartphone 100, a dock 200 (e.g. a storage/charging case or home refill and/or charging station), a personal computer (PC) 300, or a wearable device 400 (e.g. a smart watch), and a server 1000 (where communications with the server may be supported over an internet or other packet data connection 500). The electronic devices comprised in the system may communicate with the aerosol delivery device 1, either directly (as shown with solid arrows) or indirectly (shown with dashed arrows). This delivery system/aerosol delivery system may be referred to as a delivery ecosystem/aerosol delivery ecosystem.

An example aerosol delivery device 1 such as an e-cigarette may communicate directly with one or more other classes of device in a wider aerosol delivery ecosystem, including but not limited to a smartphone 100, a dock 200 (e.g. a recharging case or home refill and/or charging station), a personal computer (PC) 300, or a wearable device 400 (e.g. a smart watch). In a similar manner, the aerosol delivery device 10 such as an e-cigarette may communicate directly with another device of the same class, i.e. another aerosol delivery device. As noted above, these devices may cooperate in any suitable configuration to form a delivery system 1. This communication may be supported by wired communication circuitry of the aerosol delivery device 1 (for example, using an interface such as USB-C, micro-USB, Thunderbolt, or another wired communication interface as described further herein), or by wireless communication circuitry of the aerosol delivery device 1 (for example, a Bluetooth, ZigBee, WiFi, Wifi Direct, GSM, 2G, 3G, 4G, 5G, LTE, NFC or RFID module, or another wireless communication interface as described further herein). The aerosol delivery device 1 may be configured to connect to different ones of other classes of device using different wired or wireless communication protocols, and a data connection between the aerosol delivery device 10 and any given second device may be established using wired and/or wireless communication. It will be appreciated that other classes of device comprised in the wider delivery system may comprise communication circuitry for wired or wireless data transmission similar to that set out further herein in relation to the aerosol delivery device 1. Accordingly, a smartphone 100, a dock 200 (e.g. a home refill and/or charging station), a personal computer (PC) 300, a wearable device 400 (e.g. a smart watch) or a server 1000 may be equipped with communication circuitry comprising a Bluetooth, ZigBee, WiFi, Wifi Direct, GSM, 2G, 3G, 4G, 5G, LTE, NFC, RFID or other wireless transmission module, and/or a wired interface such as USB-C, micro-USB, Thunderbolt or other wired interface. Communication circuitry of the aerosol delivery device 1 (implemented as a single module or separate modules) may enable it to communicate with different ones of the further classes of device using different wired and/or wireless data transmission protocols.

The aerosol delivery device 1 and other classes of device in the delivery system may communicate directly or indirectly with a server 1000 via a network such as the internet 500 or other suitable packet data protocol known to the skilled person (such as those set out in the 3GPP standards for cellular wireless communications). The aerosol delivery device 1 may establish such communication directly, using one of the wireless communication protocols described further herein to communicate with communication node/transceiver infrastructure (such as a ‘base station’ or ‘evolved node-B’ in LTE terminology) which provides connectivity with the server 1000 (e.g. over a backhaul communication link). Alternatively or in addition, the aerosol delivery device 1 may establish communication with the server 1000 via another device in the delivery system 1, for example using a wired or wireless communication protocol to communicate with a smartphone 100, a dock/case 200, a personal computer (PC) 300, or a wearable device 400 which then communicates with the server 1000 (for example, via the internet 500) to either relay data to or from the aerosol delivery device 1, report upon its communications with the aerosol delivery device 1, or exchange information inferred about the aerosol delivery device 1 without a connection to the aerosol delivery device 1 being established. The smartphone 100, dock 200, or other device within the delivery ecosystem, such as a point of sale system/personal computer (PC) 300, may optionally act as a hub for one or more aerosol delivery devices 1 that only have short range transmission capabilities (provided, for example, by communication circuitry comprising a Bluetooth or RFID module). Such a hub may thus extend the battery life of an aerosol delivery device 1 whilst enabling data to be exchanged between the aerosol delivery device 1 and further devices of the aerosol delivery system 1 (for example, server 1000).

The other classes of device in the aerosol delivery system 1, such as the smartphone 100, dock 200, personal computer (or, for example, a point of sale system) 300 and/or wearable 400 may also communicate indirectly with the server 1000 via a relay device, either to fulfil an aspect of their own functionality, or on behalf of the aerosol delivery system 1 (for example as a relay or co-processing unit). These devices may also transfer data with each other, either directly or indirectly via any of the wired or wireless communication protocols set out further herein.

A given first and second device of the delivery system may generally be in either a connected or unconnected state. The unconnected state may also be referred to as an idle state, and in such a state a given first device may not be detectable by other second devices (i.e. the first device is not transmitting any signalling enabling its existence and/or identity to be determined), or it may be available for establishing a connection with a second device (i.e. it may be advertising its existence/identity using beacon/advertisement signalling). In a connected state, the first and second devices are configured such that data may be transferred from the first to the second device (e.g. ‘uplink’ transmission) and/or transferred from the second to the first device (e.g. ‘downlink’ transmission). Accordingly, establishment of a connection between a first and second device may be considered to comprise the establishment of any state wherein the two devices can exchange data, regardless of the direction of data transfer. Non-limiting examples of connected states are the establishment of an RRC connected state according to the Long Term Evolution (LTE) standard, or a bonded/paired state according to the Bluetooth standard. When a first and second device of the delivery system are configured to communicate wirelessly, a transition from an unconnected to a connected state will generally follow a procedure such as the following. In an initial enquiry step, a first device (for example, an aerosol delivery device 1) establishes the existence of a second device (for example, a smartphone 100 or case 200) by receiving a beacon signal or other identifying signal/message from the second device. In an authentication step, the first and second devices exchange messaging to establish information relating to the data transfer protocol to be used for exchanging data (for example comprising coding and encryption parameters to be used when exchanging data packets). In a data transfer step, the first and second devices transfer data over an air interface established in accordance with an agreed data transfer protocol (for example, Bluetooth, ZigBee, RFID, or other protocols described further herein). This data transmission may be bi- or uni-directional. The data communication process for wired communications may be broadly similar with the difference that data is transmitted over a wired interface as opposed to a wireless interface. Further aspects of implementation for establishment of wireless and wired communications may be found in the standard documents for communication protocols such as those listed further herein.

It will be appreciated that references herein to functionality of a controller 26 of an aerosol delivery device, in terms of monitoring usage of the aerosol delivery device, storing usage data, and establishing parameters for controlling operation of the aerosol delivery device on the basis of such usage data, may be ‘offloaded’ to a processor or controller associated with an external electronic device having a wired or wireless data connection to the aerosol delivery device, as shown schematically in FIG. 2, and described in the accompanying text. In the case where some or all of the computer operations occur on an external electronic device, resulting parameters determined for control of the aerosol delivery device may, as appropriate, are transmitted back to the aerosol delivery device over a wired or wireless data connection. Thus, throughout the present disclosure, it will be appreciated that when operations are referred to in which (i) user inputs such as selection of parameters and device modes are provided to a user input interface of the reusable device part 2, (ii) information is displayed to a user on a display of the reusable device part 2, and (iii) information is processed by a controller 22 (e.g. for determining how to control at least one aspect of the operation of the aerosol delivery system on the basis of a target operating characteristic of the aerosol delivery system and identifying information for a cartridge/consumable part), one or more of these functions may be carried out by an external electronic device (e.g. a smartphone, a refill/charging dock or case, a personal computer (PC), a wearable device (e.g. a smart watch) or a server) to which the aerosol provision system is configured to connect via a wired or wireless communication protocol using a wired or wireless data interface between the aerosol delivery system 1 and the external electronic device.

The inventors have recognised that in systems where a controller (whether comprised in a reusable device part of an aerosol delivery system, or in an external electronic device) is configured to control aspects of operation of an aerosol delivery system, it may be advantageous to base this control on what may broadly be termed a ‘context’ for the aerosol delivery system and/or a user of said system, and information about a type of at least one consumable coupled to the system for use. This recognises both that (i) the context, which may for example comprise information about a time of day, location of the system/user, and previous usage of the system, can be used to establish a target operating characteristic which is related to the current context, and that (ii) having determined a target operating characteristic (e.g. based on the context), information identifying the type of consumable part/cartridge/article coupled to the system can be used to make decisions about control of the device in order to assist the controller to operate the device in accordance with the target operating characteristic.

Thus, according to embodiments of the disclosure, an aerosol delivery system is provided for generating aerosol from a consumable part, the aerosol delivery system comprising: a sensor; and a controller, wherein the controller is configured to: establish a target operating characteristic for the aerosol delivery system; establish, using the sensor, identifying information associated with a consumable part coupled to the aerosol delivery system; identify the consumable part is one of a plurality of different types of consumable part, based on the identifying information; and control at least one aspect of the operation of the aerosol delivery system on the basis of the target operating characteristic of the aerosol delivery system and the identifying information associated with at least one consumable part coupled to the aerosol delivery system.

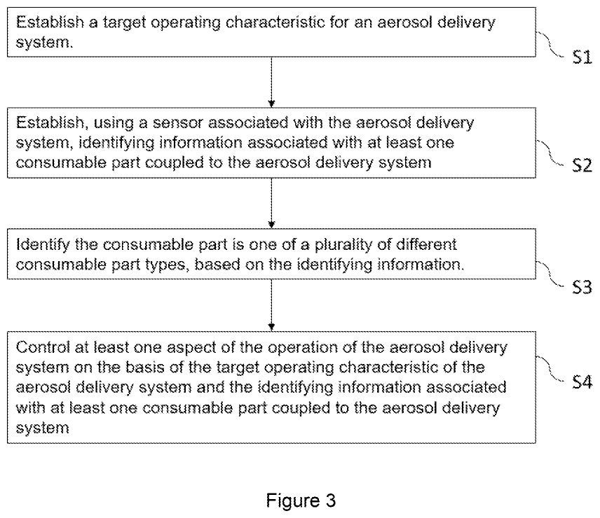

FIG. 3 outlines a method of operating a controller of an aerosol delivery system according to embodiments of the present disclosure. According to this method, in a first step S1, the controller is operable to establish a target operating characteristic for the aerosol delivery system. In a second step S2, the controller is operable to establish, using a sensor associated with the aerosol delivery system, identifying information associated with at least one consumable part coupled to the aerosol delivery system. In a third step, S3, the controller is operable to identify the consumable part is one of a plurality of different consumable part types, based on the identifying information. In a fourth step S4, the controller is operable to control at least one aspect of the operation of the aerosol delivery system on the basis of the target operating characteristic of the aerosol delivery system and the identifying information associated with at least one consumable part coupled to the aerosol delivery system

According to embodiments of the present disclosure, the aerosol delivery system is configured to establish a target operating characteristic. The term ‘target operating characteristic’ as used herein relates to a manner in which the device can be operated, and can comprise any characteristic of the aerosol delivery system which is operable to be modified in order to seek to meet a predefined manner of operation. Thus in embodiments of the disclosure, the operating characteristic may comprise:
a characteristic relating to aerosol generation, such as, for example, a rate of aerosol generation per puff, an amount of aerosol generated in a puff, a visibility of aerosol, a concentration of an active substance in the aerosol, a total quantity of active substance in a puff, a concentration of a flavouring or aerosol former in the aerosol, a total quantity of flavouring or aerosol former in the aerosol in a puff, a temperature of the aerosol, a particle size of the aerosol, or any other aerosol related characteristic.
a characteristic related to puff patterns or sessions (e.g. operation of the device over a plurality of puffs), such as, for example, a number of puffs to be provided before a supply of aerosol generating material in a consumable part/cartridge is depleted or a supply of power from a battery is no longer sufficient to permit aerosol generation by the aerosol delivery system, or cessation control characteristics, such as an elapsed time following a puff or plurality of puffs during which the aerosol delivery system is not operable to generate aerosol for a user.
a characteristic related to other device settings not directly related to generation of aerosol, such as user indication characteristics (e.g. provision of visual, aural, or haptic feedback indications by the aerosol delivery device). For example, a characteristic of this type may comprise one or more colours associated with a display element of the aerosol delivery system, one or more sounds which may be provided by the aerosol delivery system to notify the user of, for example, a low battery state, or a vibration intensity and/or temporal pattern for a haptic indication provided by the aerosol delivery system.

According to embodiments of the present disclosure, the controller of the aerosol delivery system (or the controller of an external electronic device) may determine a target operating characteristic in one of a number of different ways. For example, the controller may establish the target operating characteristic based on a time of day, or based on information about the location of a user of the aerosol delivery system, or based on a state of a user of the aerosol delivery system (wherein the state of the user is established based on signals from a further sensor), or based on information about previous usage of the aerosol delivery system by a user, or based on aggregated information about previous usage of a plurality of aerosol delivery systems by a plurality of users, or based on any combination of these classes of information.

With reference to FIG. 1, usage data/usage information established by the controller 22 of an aerosol delivery device, or the controller of an external electronic device with a data connection to the aerosol delivery device, may comprise information about inhalation events (also referred to herein as ‘puffs’) as detected on the basis of signals received by controller from an activation device comprising an airflow sensor 30. When a rate of airflow (and/or a drop in pressure) detected by the airflow sensor 30 increases beyond a predetermined threshold, a puff may be determined by the controller 22 to have started, and the time of the puff initiation may be stored in a memory element associated with controller 22. When the rate of airflow (and/or a drop in pressure) detected by the airflow sensor 30 drops again below the predetermined threshold (or a second, different threshold to account for sensor hysteresis), the puff may be determined by the controller 22 to have ended, and the time of the puff end may also be stored in a memory element associated with controller 22. This timing information may be used to determine the duration of each of a plurality of puffs, and the delay between subsequent puffs. Alternatively, the puff start and end times described above may in other embodiments be determined based on the times at which a user respectively presses and releases the button 14, with a supply of power to the heater 48 being initiated and ended at these same points in time.

The controller 26 may further establish usage data by monitoring a strength of user inhalation associated with each of a plurality of puffs and output by the airflow sensor 30 and store this in the memory element. This may comprise for example a maximum inhalation strength during each puff, or a time-varying profile of inhalation strength during each puff. The power supplied to the heater 48 during each puff may also be monitored and stored in the memory element. The power supplied to the heater by the controller 22 may be adjusted by a user from puff to puff or from session to session using a user input interface 14 associated with the aerosol delivery device, or associated with an external electronic device, such as for example a smartphone 100 having a data connection to the aerosol delivery device. For example, a power level to be supplied to the heater may be selected via a software application (APP) running on a smartphone 100, which this power level being indicated to the controller 22 via a wireless data connection between smartphone 100 and the aerosol delivery device as described further herein. The profile of power level delivered to the heater 48 over time may be monitored by controller 22 and stored as usage data.

In other embodiments, usage data may also comprise parameters derived based on sensing other interactions of a user with the aerosol delivery system which are not directly related to inhalation. For example, usage data may comprise:
Data about location over time of the aerosol delivery device, or an external electronic device such as a smartphone, based on GPS location tracking over time, according to GPS tracking approaches known to the person skilled in the art.
Data about a type of consumable part/cartridge used in the device, and optionally the quantity of aerosol forming material, active substance, and flavour material, in the consumable part.
Data relating to selection of parameters or manual input of data by a user to the aerosol delivery device or an associated electronic device of the aerosol delivery system. For example usage data may comprise a record of how a user has adjusted a level of power to be supplied to the heater 48 of the aerosol delivery device over time.
Data relating to physical interactions with the user with the aerosol delivery device which are not directly related to airflow through the device. For example, suitable sensors (e.g. biosensors) may be positioned on an outer housing of the aerosol delivery device according to approaches known to the skilled person to monitor the pressure with which the user holds the device, or a temperature of the user's skin as they hold the device, or the acceleration of the device, to give a few non-limiting examples. A state of the user may be established based on the data relating to physical interactions of the user, for example, an estimated stress state. In some embodiments, biosensors integrated into the housing of an aerosol delivery system of the present disclosure provide interaction data to a controller, and a stress state of the user is computed using an appropriate function of the interaction data. This function may be established based on experimental approaches known to the skilled person for identifying a stress state of a user, and mapping the stress state to the interaction data (e.g. rate of sweating, skin temperature, heart rate, blood oxygen level, grip strength) by fitting an appropriate function.

It will be appreciated that usage data as described herein may comprise information about previous usage of the aerosol delivery system by a user, or may comprise information based on aggregated information about previous usage of a plurality of aerosol delivery systems by a plurality of users. In the latter case, this information may be provided to a central server (e.g. server 1000 of FIG. 2) over wireless data communication links between the server and a plurality of different aerosol delivery systems. The server may analyse the aggregated usage data (for example, to determine averaged usage data over the plurality of users/aerosol delivery systems), and the aggregated and optionally analysed usage data may then be transmitted from the server 1000 to individual aerosol delivery systems for use in approaches as described herein, or may be transmitted to a further electronic device (such as a smartphone) for use by an aerosol delivery system having a wireless data connection to the smartphone as described further herein.

Where a factor such as location, time of day, or user state, is used by the controller to establish a target operating characteristic, this may be based on information about previous usage of the aerosol delivery system by a user, and the controller may establish the target operating characteristic at a given time of day in a manner which targets a value of the same operating characteristic associated with the same time of day in one or more previous days. Thus in embodiments of the disclosure, the controller establishes target operating characteristic based on the time of day, and does so by referencing usage data for one or more previous days to identify a characteristic value of any of the operating characteristics described herein on the basis of a value of said operating characteristic relating to the same time on the one or more previous days. Thus, to take one non-limiting example, the controller may establish the current time of day is 1800 H, and establish an average rate of aerosol generation associated with 1800 H over each of a preceding number of days (for example, the preceding 7 days). This may be established by, for example, polling heater power data and aerosol generating material data comprised in usage data relating to a period of 1 h centred on 1800 H in each of the preceding 7 days. For each of the preceding 7 days, the average rate of aerosol generation over all puffs occurring in the hour centred on 1800 H may be estimated using information comprised in the usage data specifying the power delivered to the heater, and the type of aerosol forming material associated with the consumable part coupled to the aerosol delivery system (as identified based on identifying information as described further herein). This estimation may be based on looking up an aerosol generation rate in a lookup table which is derived based on experimental data which provides values for aerosol generation rate as a function of heater power and the type of aerosol forming material. Based on determining, on the basis of usage data/information, an average rate of aerosol generation per puff in a period of 1 hour centred on 1800 H in one or more previous days (e.g. the average over 7 previous days), the controller may establish this rate as the target operating characteristic. It will be appreciated that the use of a period of 7 days is illustrative, and that other periods of time (i.e. a different preceding number of days) may be used to determine the average rate of aerosol generation, for example, 14 days, 21 days, 28 days, 30 days, 60 days, or 90 days.

It will be appreciated this approach for establishing a target operating characteristic may be applied in respect of other operating characteristics as described further herein, and may be carried out by using any usage data as described further herein. In general, the controller may identify a time of day, location of the user, or state of the user, using approaches set out herein; then identify one or more previous instances or periods matching the same time of day, location, or state of the user; then poll usage data to identify an operating characteristic in the usage data which is associated with the previous instance(s) or period(s); then set the target operating characteristic for the present time as the value or status of the operating characteristic in the matched instance(s) or period(s).

According to embodiments of the disclosure, the controller of the aerosol delivery system is configured to establish, via a sensor, identifying information associated with a cartridge/consumable part coupled to the aerosol delivery system, and to identify the consumable part is one of a plurality of different consumable part types based on the identifying information. In embodiments of the disclosure, the identifying information is comprised in or on a consumable part, or is comprised in or on packaging for the consumable part.

FIG. 1 shows a configuration according to some embodiments of the disclosure, by which identifying information may be established. FIG. 1 shows a sensor 23, connected to controller 22, which is configured to detect an identifier 43 associated with a consumable part 4. The identifier may comprise any form of identifier known to the skilled person which can be detected by a sensor, and which can carry identifying information allowing the consumable type with which the identifier is associated to be uniquely identified. Thus in embodiments of the disclosure, the sensor 23 comprises an optical sensor (e.g. a camera), and the controller 22 is configured to establish, via the sensor 23, identifying information comprised in an optically readable identifier 43. The optical sensor 23 may comprise an illumination source (e.g. an LED) to illuminate the identifier for reading by the sensor. The identifier may comprise a QR code or bar-code which encodes identifying information for the consumable part. To avoid the requirement for an optical sensor 23 to be able to acquire an image (as required for discriminating information in QR codes or bar-codes), the optical sensor 23 may be a simpler sensor configured to discriminate a wavelength of light received from the identifier on the basis of an illuminating signal directed at the identifier. In these embodiments, different types of consumable parts may have identifiers of different colours, such that a type of consumable part may be distinguished based on identifying information comprising a wavelength-dependent signal from the optical sensor 23.

In embodiments of the present disclosure, the sensor 23 comprises circuitry configured to read data from a passive data storage element such as an radio frequency identification, RFID, or near-field communication, NFC, tag, and the identifier 43 comprises a passive data storage element such as an RFID tag or NFC tag on which identifying information is stored. An identifier comprising a passive storage element may be wirelessly read by the sensor 23 (as in the case of RFIC and NFC tags), or may be read by a wired connection between the sensor 23 and the identifier 43 when the consumable part 4 is coupled to the reusable part 2 of the aerosol delivery system. For example, the identifier 43 may comprise a chip on which identifying information for the consumable part is stored, and the chip is read by a sensor 23 integrated in the controller 22, using a wired data connection comprising an electrical interface communicating between the reusable and consumable parts when the consumable part is coupled to the reusable part for use. This interface may be configured in the same manner as described further herein for supplying electrical energy from controller 22 to a heater 48 of the consumable part (e.g. using appropriate contact pads or pins, respectively arranged on contacting parts of the consumable part and reusable part).

It will be appreciated that in some embodiments, the sensor 23 may be integrated into the controller 22. In embodiments of the disclosure, the sensor 23 comprises resistance measurement circuitry integrated into controller 22, which determines a resistance of circuitry comprised in the consumable part (e.g. the resistance of a heater) using approaches for resistance measurement known to the skilled person. In these embodiments, the resistance of the circuitry (e.g. the heating element) comprises identifying information for the consumable part.

In some embodiments, the identifying information may be input via a sensor comprising a user input interface (e.g. a button 14, or touchscreen interface 24), whereby the user may provide a user input identifying the type of consumable type. For example, the user may use button 14 to toggle through a menu of consumable type options displayed on a display 24, and select the type of consumable coupled to the device from the menu. The selection of a specific type of consumable comprises a provision of identifying information for the consumable to the controller 22.

It will be appreciated that in any of the examples provided above, the identifier 43 may be comprised in packaging of the consumable, with the identifier 43 being detected by the sensor 23 of the aerosol delivery system via a user bringing the sensor 23 into proximity with the identifier 43 of the packaging.

In some embodiments, the sensor 23 comprises a transceiver configured to support a data connection between the aerosol delivery system and an external electronic device as described further herein. Thus establishing identifying information using the sensor may comprise receiving data identifying a consumable part over a wired or wireless data connection between the aerosol delivery system and an external electronic device. For example, a user may use an external electronic device comprising a smartphone running an application (APP) which relates to operation of the aerosol delivery system. The user may scan an identifier comprising a QR code on a consumable part or packaging for the consumable part, using a camera associated with the smartphone, from which the APP determines identifying information associated with the consumable part or packaging. The identifying information may then be transmitted to the aerosol delivery device over the data connection for use by the controller of the aerosol delivery device, or a controller of the smartphone may carry out functions of establishing a target operating characteristic for the aerosol delivery system (following the same approaches as described herein for a controller of the aerosol delivery system), and transmit to the aerosol delivery system, over the data communication link, control data for controlling at least one aspect of the operation of the aerosol delivery system on the basis of the target operating characteristic of the aerosol delivery system and the identifying information associated with at least one consumable part coupled to the aerosol delivery system.

According to embodiments of the present disclosure, the identifying information associated with the consumable part coupled to the aerosol delivery system directly comprises information about one or more physical characteristics of the consumable part, or may be used by the controller of the aerosol delivery device to determine physical characteristics of a consumable part, for example, by referencing a table or similar data structure which maps physical characteristics to information identifying a particular type of consumable part.

In embodiments of the disclosure, physical characteristics of the consumable part comprised in the identifying information, or established by the controller on the basis of the identifying information, may comprise one or more of: a type of active ingredient comprised in the consumable part, a type of flavouring comprised in the consumable part, a concentration of an active substance comprised in the consumable part, a concentration of a flavouring comprised in the consumable part, a type of aerosol forming material comprised in the consumable part, a concentration of an aerosol forming material comprised in the consumable part, a resistance of a heating element in the consumable part, an amount of aerosol generating material comprised in the consumable part, and a number of separately controllable aerosol generators comprised in the consumable part. Where this information is directly comprised in (for example encoded in) identifying information, the identifying information may comprise an index representing a characteristic of a consumable part with which the identifying information is associated. For example, a number of bits comprised in data encoded in an identifier may be used to indicate a type of active ingredient comprised in the consumable part. For example, two bits may be used to encode four indices, respectively identifying whether an active substance comprised in the consumable part is, for example, nicotine, caffeine, cannabidiol, or taurine (or any other active substance described herein). Alternatively, n bits may be used to individually indicate for each of n active substances whether or not the consumable comprises the active substance. The same may be applied in respect of any other constituent of a consumable part (for example, to indicate whether or not a given flavouring or aerosol former is comprised in the consumable part). More generally, information about any physical characteristic described herein may be directly encoded in the identifying information received using the sensor. Where the characteristic describes a quantity (e.g. a concentration or volume of a particular material), a number of bits used to represent the quantity may be selected by the skilled person based on a desired granularity for specifying the quantity. For example, 4 bits may be used to encode 16 different possible concentrations of a material such as an active substance in the consumable (e.g. in an aerosol generating liquid in the consumable).

In other embodiments, the identifying information provided to the controller using the sensor does not directly identify one or more physical characteristics of the consumable part. Thus the identifying information may identify the type of consumable part from among a plurality of possible consumable parts of different types (e.g. having different physical characteristics). Where the identifier encodes data in the form of bits, the controller may map a plurality of cartridge types to a plurality of indices represented by the identifier. Thus, for example, where an aerosol delivery system is configured to be coupled to one of four different consumable part types part (i.e. Type A, Type B, Type C, and Type D), having different physical characteristics, each type of cartridge may be indicated by a different two-bit index (i.e. Type A=00, Type B=01, Type C=10, Type D=11) stored on an identifier which is read by a sensor, or provided via a sensor by a user or an external electronic device as described further herein. Where the identifier comprises a scalar value (e.g. where the identifying information comprises a heater resistance or wavelength-dependent optical sensor-output value as described further herein), the controller 22 may determine the type of consumable from the identifying information by establishing the scalar value falls within a certain predefined range. For example, where the identifying information comprises a measured resistance of a heater comprised in a consumable part, there may be four types of consumable part (i.e. Type A, Type B, Type C, and Type D) having different physical characteristics. The heater resistance may be configured to be different for each type, for example, being set to 2 Ohms for Type A, 2.2 Ohms for Type B, 2.4 Ohms for Type C, and 2.6 Ohms for Type D. When a consumable part is coupled to the aerosol delivery system, the controller 22 in these embodiments measures the resistance of the heater using conventional approaches, and then determines whether the resistance R falls into range A (0<R<2.1 Ohms), range B (2.1 R≤2.3 Ohms), range C (2.3 R≤2.5 Ohms), or range D (2.5<R Ohms). The ranges A to D are mapped to respective types A to D, such that if, for example, the measured resistance is 2.2 Ohms, the consumable part is determined to be a Type B cartridge.

Once the cartridge type has been determined by the controller 22, at least one physical characteristic of the cartridge may be determined by the controller 22 based on the cartridge type by referencing a look-up table which maps physical characteristics to identifying information. The look up table may be comprised in an external electronic device (e.g. a smartphone or a server) and the controller 22 may query the look-up table by transmitting a request comprising the identifying information for the cartridge to the external electronic device, and receiving the corresponding physical characteristic(s) from the external electronic device.

It will be appreciated that in some embodiments, the identifying information is not used to establish one or more physical characteristics of a consumable part with which the identifying information is associated. The identifying information may directly comprise, or be used to establish (e.g. via a look-up table) a parameter which is used to determine how to control at least one aspect of the operation of the aerosol delivery system according to approaches set out herein, without an intermediate step of establishing physical characteristics of the consumable from the identifying information.

Thus an aerosol delivery system according to the present disclosure establishes, using a sensor, identifying information associated with at least one consumable part coupled to the aerosol delivery system, which identifies the consumable part as being a particular type of consumable part (i.e. one of a plurality of consumable part types having different physical characteristics). Having established this information, and a target operating characteristic for the aerosol delivery system, the aerosol delivery system is configured to control at least one aspect of the operation of the aerosol delivery system on the basis of the target operating characteristic of the aerosol delivery system and the identifying information associated with at least one consumable part coupled to the aerosol delivery system, according to approaches described further herein.

In some embodiments, the aspect of operation of the aerosol delivery system which is controlled, comprises an aspect directly related to a target operating characteristic as described further herein (for example, a characteristic relating to aerosol generation, a characteristic related to puff patterns or sessions, or a characteristic related to other device settings not directly related to generation of aerosol, such as a user indication characteristic).

Thus in some embodiments of the present disclosure, the aspect of operation comprises control of at least one aerosol generation parameter. The at least one aerosol generation parameter may comprise respective power levels to be delivered to each of one or more aerosol generating elements comprised in each of one or more consumable parts, and configured to aerosolise aerosol generating material comprised in the one or more consumable parts coupled to the aerosol delivery system.

Thus in one example, the target operating characteristic comprises a rate of delivery of an active substance (which may, as described herein, be established based on previous usage information, such that, for example, the target rate of delivery is based on a rate of delivery provided at a similar time of day in one or more previous days by the same user). The identifying information established for the consumable in this example may comprise a concentration of an active substance comprised in the consumable part, or be used to reference the concentration of an active substance with a predefined association to the type of consumable part. In this example, the control at least one aspect of the operation of the aerosol delivery system comprises varying the power delivered to the heater in a manner which seeks to provide the target rate of delivery based on the concentration of the active substance in the consumable part (e.g. comprised in a supply of liquid contained therein). Thus the controller 22 may reference a look-up table or similar data structure which allows identification of a suitable power level to provide to the heater, based on inputting the target active substance delivery rate and the concentration of active substance. The look-up table may be experimentally derived based on generating aerosol using different levels of heating power, and using consumable parts having different concentrations of the active substance, to explore the parameter space and derive active substance delivery rates (e.g. using laboratory aerosol analysis) for a range of values of heater power and active substance concentration. Thus heater power can be automatically adjusted by the controller 22 of the aerosol delivery system to deliver a target rate of active substance in a way which takes account of different concentrations of active substance in different types of consumable part which may be coupled to the aerosol delivery system.

It will be appreciated that though the specific example just outlined uses delivery rate of active substance as the target characteristic, uses identifying information to establish a concentration of active substance of a consumable coupled to the aerosol delivery device, and controls heater power on the basis of the target characteristic and the identifying information, other target characteristics, identifying information, and control aspects described herein may be substituted without departing from the present disclosure.

Thus, in another example of an aerosol delivery system according to the present disclosure, the target operating characteristic comprises a target degree of aerosol visibility. This may be established based on context information comprising a user location, and usage data about previous usage of the aerosol delivery system at said location. Thus a GPS module associated with the aerosol delivery system (e.g. comprised in the controller 22, or comprised in a smartphone with a data connection to the aerosol delivery system) may determine that the user is in a location which is associated with a requirement for low visibility aerosol. For example, the GPS location may be compared to a user-defined ‘work’ location, for which the user has specified (e.g. via an APP on a smartphone) that they wish to use low visibility aerosol, or usage data may be searched to determine what aerosol generation parameters have been previously used in the same location, and determine on this basis that a user conventionally uses aerosol generation parameters associated with a lower visibility of aerosol. In an embodiment, the aerosol delivery system comprises a consumable part having two reservoirs, one containing an aerosol generating material comprising vegetable glycerine (VG) and one containing an aerosol generating material comprising polyethylene glycol (PG), which can be selectively aerosolised (e.g. via two heaters respectively configured as described herein to aerosolise material from each respective reservoir). By supplying different ratios of power to the first and second heater, the respective aerosolisation rates of the VG aerosol generating material and the PG aerosol generating material can be controlled, and the visibility of the resulting aerosol can be adjusted. In other embodiments, two separate consumable parts are configured to be coupled to the aerosol delivery system, one comprising PG and one comprising VG, with the consumable parts being selectively heatable by the controller 22 using different ratios of heating power to adjust the visibility of the resulting aerosol generated by the consumable parts. The identifying information established by the controller 22 of the aerosol delivery device may be used to establish the concentration of each of PG and VG in the aerosol generating materials comprised in the one or more consumable parts coupled to the aerosol delivery system. The identifying information may be established using a sensor according to any approach described herein. It will be appreciated that when a plurality of consumables are configured for coupling to the aerosol delivery system, each consumable is associated with identifying information which may be established by the controller 22. In some embodiments, the aerosol delivery system comprises a separate sensor for establishing identifying information for each of the consumable parts, and in other embodiments a single sensor is used to establish identifying information for all consumable parts coupled to the aerosol delivery system. In the present example, the identifying information is used to establish a concentration of VG in a first aerosol generating material available for aerosolisation by a first heater, and a concentration of PG in a second aerosol generating material available for aerosolisation by a second heater. Control of the at least one aspect of the operation of the aerosol delivery system comprises modifying the respective levels of power to deliver to the first and second heaters to target a certain visibility of aerosol. For example, if a lower visibility of aerosol is required on the basis of the target, comparatively more power may be delivered to the second heater versus the first heater, and if a higher visibility of aerosol is required, comparatively more power may be delivered to the first heater versus the second heater.

In a further example of an embodiment according to the present disclosure, the target operating characteristic comprises a number of puffs to be provided to a user before depletion of a supply of aerosol generating material in a consumable part. This target may be determined on the basis of previous usage data. For example, the controller may determine that a user conventionally obtains 200 puffs from a single consumable part, based on analysis of usage data relating to previous usage of the device. On this basis, the controller may establish that 50 puffs have been taken since the user connected the current consumable part to the aerosol generating system (e.g. based on identification of the current consumable part on the basis of an identifier as described further herein). Thus the target operating characteristic may comprise providing 150 puffs from the remaining aerosol generating material comprised in the consumable part. In this example, the identifying information comprises an amount of aerosol generating material remaining in the consumable part. In the current example, this is obtained by reading an identifier stored on a re-writable memory element of the consumable part (e.g. an RFID or NFC chip/trace). The controller in this example computes mass loss of aerosol generating material per puff using information about power delivered to the heater, duration of the puff, and information about the type of aerosol generating material in the consumable part (e.g. established on the basis of identifying information associated with the consumable part), using approaches for mass loss determination known to the skilled person. Before the consumable part is first used to generate aerosol, the consumable part identifier comprises information representing an amount of aerosol generating material comprised in the consumable part (e.g. 2 ml of aerosol generating material). After each puff, the controller 22 updates the information to account for the mass loss of the puff (e.g. by subtracting the estimated mass loss during the puff from the value representing the previous amount of aerosol generating material stored on the identifier). Thus the identifier indicates the remaining amount of aerosol generating material in the consumable part, with this being received via the sensor as identifying information. Based on the identifying information specifying the remaining amount of aerosol generating material in the cartridge, and the target operating characteristic comprising providing 150 puffs from the remaining aerosol generating material, the controller controls at least one aspect of the operation of the device, such as modifying the power delivered to the heater, and/or the duration of each of a plurality of future puffs, in order to seek to obtain 150 puffs from the remaining aerosol generating material. This determination may use the same relationship between heater power, type of aerosol generating material, and mass loss rate of aerosol generating material, to compute a total aerosolisation time required to aerosolise the remaining aerosol at a given level of heater power, and control puff length for the next 150 puffs to be 1/150^{th} of this total aerosolisation time; or the device may multiply the average puff length of the user, determined from usage data, by 150 puffs, to obtain a target aerosolisation time, and compute the level of power required to provide this aerosolisation time based on the remaining amount of aerosol generating material in the consumable part. Furthermore, the controller may deliver more power per puff when the usage data indicates that the inter-puff duration in a preceding period has been shorter, and may deliver less power per puff when the usage data indicates that the inter-puff duration in a preceding period has been longer.

Though the foregoing disclosure has been directed to operations carried out by a controller of an aerosol delivery system, it will be appreciated that various of the operations may be carried out by an external electronic device configured to establish a data communication link with the controller of the aerosol delivery system, according to approaches set out further herein. Thus, any of the operations of establishing a target operating characteristic, establishing identifying information using a sensor, and identifying one or more consumable parts, may be carried out by an external electronic device, such as a smartphone, wearable device, refill and/or charging dock, or server. Thus, according to embodiments of the present disclosure, there may be provided an electronic device comprising: a sensor; a transceiver configured to establish a data connection with an aerosol delivery system; and a controller, wherein the controller is configured to: establish a target operating characteristic for the aerosol delivery system; establish, via the sensor, identifying information associated with at least one consumable part coupled to the aerosol delivery system; identify the consumable part is one of a plurality of different consumable part types, based on the identifying information; and transmit to the aerosol delivery system, via the transceiver, control data for controlling at least one aspect of the operation of the aerosol delivery system on the basis of the target operating characteristic of the aerosol delivery system and the identifying information associated with at least one consumable part coupled to the aerosol delivery system.

Thus there has been described an aerosol delivery system for generating aerosol from a consumable part, the aerosol delivery system comprising: a sensor; and a controller, wherein the controller is configured to: establish a target operating characteristic for the aerosol delivery system; establish, using the sensor, identifying information associated with a consumable part coupled to the aerosol delivery system; identify the consumable part is one of a plurality of different types of consumable part, based on the identifying information; and control at least one aspect of the operation of the aerosol delivery system on the basis of the target operating characteristic of the aerosol delivery system and the identifying information associated with at least one consumable part coupled to the aerosol delivery system.

The various embodiments described herein are presented only to assist in understanding and teaching the claimed features. These embodiments are provided as a representative sample of embodiments only, and are not exhaustive and/or exclusive. It is to be understood that advantages, embodiments, examples, functions, features, structures, and/or other aspects described herein are not to be considered limitations on the scope of the invention as defined by the claims or limitations on equivalents to the claims, and that other embodiments may be utilised and modifications may be made without departing from the scope of the claimed invention. Various embodiments of the invention may suitably comprise, consist of, or consist essentially of, appropriate combinations of the disclosed elements, components, features, parts, steps, means, etc, other than those specifically described herein. In addition, this disclosure may include other inventions not presently claimed, but which may be claimed in future. The delivery system described herein can be implemented as a combustible aerosol provision system, a non-combustible aerosol provision system or an aerosol-free delivery system.

1. An aerosol delivery system for generating aerosol from a consumable part, the aerosol delivery system comprising:
a sensor; and
a controller, wherein the controller is configured to:
establish a target operating characteristic for the aerosol delivery system;
establish, using the sensor, identifying information associated with a consumable part coupled to the aerosol delivery system;
identify the consumable part is one of a plurality of different types of consumable part, based on the identifying information; and
control at least one aspect of the operation of the aerosol delivery system on the basis of the target operating characteristic of the aerosol delivery system and the identifying information associated with at least one consumable part coupled to the aerosol delivery system.

2. The aerosol delivery system of claim 1, wherein the controller is configured to establish the target operating characteristic based on a time of day.

3. The aerosol delivery system of claim 1, wherein the controller is configured to establish the target operating characteristic based on information about the location of a user of the aerosol delivery system.

4. The aerosol delivery system of claim 1, further comprising a further sensor to detect interaction of a user with the aerosol delivery system, wherein the controller is configured to establish the target operating characteristic based on a state of a user of the aerosol delivery system, wherein the state of the user is established based on signals from the further sensor.

5. The aerosol delivery system of claim 1, wherein the controller is configured to establish the target operating characteristic based on information about previous usage of the aerosol delivery system by a user.

6. The aerosol delivery system of claim 5, wherein information about previous usage of the aerosol delivery system comprises aggregated information about previous usage of a plurality of aerosol delivery systems by a plurality of users.

7. The aerosol delivery system of claim 1, wherein the controller is configured to establish, via the sensor, identifying information comprised in or on the consumable part.

8. The aerosol delivery system of claim 1, wherein the controller is configured to establish, via the sensor, identifying information comprised in or on packaging for the consumable part.

9. The aerosol delivery system of claim 7, wherein the sensor is an optical sensor, and the controller is configured to establish, via the sensor, identifying information comprised in an optically readable identifier.

10. The aerosol delivery system of claim 7, wherein the sensor is a resistance sensor, and the controller is configured to establish, via the sensor, identifying information comprising a resistance associated with circuitry comprised in the consumable part.

11. The aerosol delivery system of claim 8, wherein the resistance comprises a resistance associated with a heater comprised in the consumable part.

12. The aerosol delivery system of any of claim 7, wherein the controller is configured to establish, via the sensor, identifying information comprised in data stored on a memory element.

13. The aerosol delivery system of claim 12, wherein the memory element is comprised in a chip, a radio frequency identification, RFID, tag, or a near field communication, NFC, tag.

14. The aerosol delivery system of claim 1, wherein the identifying information comprises information about one or more physical characteristics of the consumable part.

15. The aerosol delivery system of claim 1, wherein the aerosol delivery system is configured to receive the identifying information and derive one or more physical characteristics of the consumable part by referencing a look-up table which maps physical characteristics to identifying information.

16. The aerosol delivery system of claim 14, wherein the one or more physical characteristics of the consumable part comprise one or more of: a type of active ingredient comprised in the consumable part, a type of flavouring comprised in the consumable part, a concentration of an active substance comprised in the consumable part, a concentration of a flavouring comprised in the consumable part, a type of aerosol forming material comprised in the consumable part, a concentration of an aerosol forming material comprised in the consumable part, a resistance of a heating element in the consumable part, an amount of aerosol generating material comprised in the consumable part, and a number of separately controllable aerosol generators comprised in the consumable part.

17. The aerosol delivery system of claim 1, wherein the aerosol delivery system is configured to be coupled simultaneously to a plurality of consumable parts, and the controller is configured to separately identify each of a plurality of consumable parts coupled to the aerosol delivery system as being one of a plurality of different consumable part types based on identifying information associated with each consumable part.

18. The aerosol delivery system of claim 1, wherein the control of at least one aspect of the operation of the aerosol delivery system comprises control of at least one aerosol generation parameter.

19. The aerosol delivery system of claim 18, wherein the control of at least one aspect of the operation of the aerosol delivery system comprises control of a ratio of rates of aerosolisation, by one or more aerosol generating elements, of each of a first and second aerosol generating material comprised in one or more consumable parts coupled to the aerosol delivery system.

20. The aerosol delivery system of claim 18, wherein the at least one aerosol generation parameter comprises respective power levels to be delivered to each of one or more aerosol generating elements configured to aerosolise aerosol generating material comprised in one or more consumable parts coupled to the aerosol delivery system.

21. The aerosol delivery system of claim 1, further comprising the consumable part associated with identifying information.

22. The aerosol delivery system of claim 1, comprising a transceiver configured to establish a data connection with an external electronic device.

23. The aerosol delivery system of claim 22, wherein the controller is configured to establish the target operating characteristic based on data received from the external electronic device over the data connection.

24. The aerosol delivery system of claim 22, wherein the transceiver comprises the sensor, and the controller is configured to establish the identifying information based on data received from the external electronic device over the data connection.

25. The aerosol delivery system of claim 22, wherein the controller is configured to control the at least one aspect of the operation of the aerosol delivery system on the basis a target operating characteristic of the aerosol delivery system and/or identifying information associated with at least one consumable part coupled to the aerosol delivery system received from the external electronic device over the data connection.

26. A method of controlling an aerosol delivery system comprising a sensor and a controller, the method comprising operating the controller to carry out the steps of:
establishing a target operating characteristic for the aerosol delivery system;
establishing, using the sensor, identifying information associated with at least one consumable part coupled to the aerosol delivery system;
identifying the consumable part is one of a plurality of different consumable part types, based on the identifying information; and
controlling at least one aspect of the operation of the aerosol delivery system on the basis of the target operating characteristic of the aerosol delivery system and the identifying information associated with at least one consumable part coupled to the aerosol delivery system.

27. A computer readable storage medium comprising instructions which, when executed by a processor, performs the method of claim 26.

28. An electronic device, the electronic device comprising:
a sensor;
a transceiver configured to establish a data connection with an aerosol delivery system; and
a controller, wherein the controller is configured to:
establish a target operating characteristic for the aerosol delivery system;
establish, via the sensor, identifying information associated with at least one consumable part coupled to the aerosol delivery system;
identify the consumable part is one of a plurality of different consumable part types, based on the identifying information; and
transmit to the aerosol delivery system, via the transceiver, control data for controlling at least one aspect of the operation of the aerosol delivery system on the basis of the target operating characteristic of the aerosol delivery system and the identifying information associated with at least one consumable part coupled to the aerosol delivery system.

29. Aerosol delivery system means for generating aerosol from a consumable part, the aerosol delivery system means comprising:
sensor means; and
controller means, wherein the controller means are configured to:
establish a target operating characteristic for the aerosol delivery system means;
establish, using the sensor means, identifying information associated with consumable part means coupled to the aerosol delivery system means;
identify the consumable part is one of a plurality of different types of consumable part, based on the identifying information; and
control at least one aspect of the operation of the aerosol delivery system means on the basis of the target operating characteristic of the aerosol delivery system means and the identifying information associated with at least one consumable part means coupled to the aerosol delivery system means.

30. The aerosol delivery system of claim 8, wherein the sensor is an optical sensor, and the controller is configured to establish, via the sensor, identifying information comprised in an optically readable identifier.

31. The aerosol delivery system of claim 8, wherein the controller is configured to establish, via the sensor, identifying information comprised in data stored on a memory element.

32. The aerosol delivery system of claim 31, wherein the memory element is comprised in a chip, a radio frequency identification, RFID, tag, or a near field communication, NFC, tag.

33. The aerosol delivery system of claim 15, wherein the one or more physical characteristics of the consumable part comprise one or more of: a type of active ingredient comprised in the consumable part, a type of flavouring comprised in the consumable part, a concentration of an active substance comprised in the consumable part, a concentration of a flavouring comprised in the consumable part, a type of aerosol forming material comprised in the consumable part, a concentration of an aerosol forming material comprised in the consumable part, a resistance of a heating element in the consumable part, an amount of aerosol generating material comprised in the consumable part, and a number of separately controllable aerosol generators comprised in the consumable part.
